(19) United States
(12) Patent Application Publication
(10) Pub. No.: US 2006/0055173 A1
(43) Pub. Date: Mar. 16, 2006

(54) Cooled electrical generator

(76) Inventor: Bianchi Gianfranco, Genova (IT)

Correspondence Address: Mayer Fortkort & Williams, 251 North Avenue West 2nd Floor, Westfield, NJ, 07090, US

(21) Appl. No.: 10/538,551

(22) PCT Filed: Dec. 12, 2002
(86) PCT No.: PCT/IT02/00784

§ 371 Date: Jun. 13, 2005

(51) Int. Cl. H02K 7/18

(52) U.S. Cl. 290/1 B

(57) ABSTRACT

The invention relates to an operating unit (1) in which an internal-combustion engine (3) operates an electric power generator (5). The unit also has associated a cooling apparatus such as a heat pump whose compressor (4) is actuated by the internal-combustion engine, while the evaporator or at least one part thereof allows cold air to be obtained for cooling the generator.

The present invention relates to operating units of the transportable type, which are used for the production of electric power in sea or land applications, such as for example boats, caravans, campers, dwellings and civil settlements which do not have access to the mains electricity supply, building yards, campsites and the like.

The operating units considered herein comprise an internal-combustion engine which operates an alternator in the case of generation of alternating current or a dynamo in the case of direct current; for the sake of brevity, below the term “generator” will be used without being specifically limited to an alternator or dynamo. For safety and noise-reduction purposes the aforesaid units are usually housed in a closed sound-proof case or cocoon, inside which therefore high temperatures may be reached owing to the heat produced by the generator and the internal-combustion engine.

The operating conditions of these units may be even more severe in the case of their use in hot environments, either indoor likewise the engine room of a boat or outdoor as in zones highly exposed to solar radiation (such as, for example, sites or installations in hot climates or desert zones).

As a consequence there exists the need to increase the operational reliability of the aforementioned units under these severe conditions and in particular of the generator, since the latter is a critical component in view of the fact that it tends to heat up per se during operation.

For this purpose solutions are known where the generator is cooled with water or another liquid; this, however, results in a more complex design of the generator since it must have therein a hydraulic circuit suitable to avoid any risk of leakange, because otherwise the cooling liquid could come into contact with the parts conveying electrical current.

Operating units also exist where the cooling liquid of the generator and that of the internal-combustion engine exchange heat with external water, usually seawater since these units are intended mainly for marine applications.

An example of these units is described in Italian Utility Model registration No. 00224790, where a generator is cooled by an air flow previously passing through a water-air heat exchanger incorporated within the unit.

As long as the water circulating inside the heat exchanger of this unit is taken from the sea, and is therefore at a temperature sufficiently low to ensure a good level of heat exchange with the air cooling the generator, operation thereof is regular and reliable.

It can be understood, however, that if there is no supply of external water like that provided by the sea (lake, river or else), such an operating unit is unable to function reliably.

The technical problem underlying the present invention is therefore that of providing an operating unit comprising an electric power generator, able to function also under the severe conditions referred to above.

The idea for solving this problem consists in an operating unit which further to the generator, it comprises also a cooling apparatus actuated by the internal-combustion engine; such a unit is indeed capable of producing on its own the amount of cold necessary to obtain the low-temperature air for cooling the generator and, if necessary, other parts of the operating unit and the environment in which it is enclosed.

The characterising features of such an operating unit are stated in the accompanying claims; they will appear more clearly from the description provided below, of preferred non-exclusive embodiments of the invention shown in the accompanying drawings, wherein:

FIG. 1 is a perspective view of a first embodiment of operating unit according to the invention;

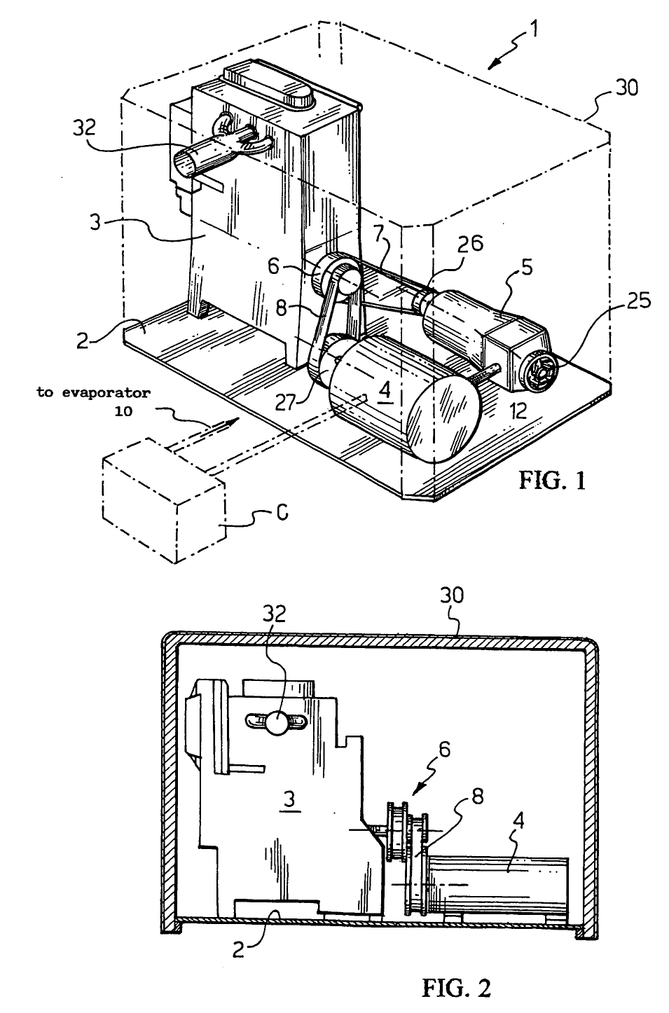

FIG. 2 is a side view of the unit of FIG. 1;

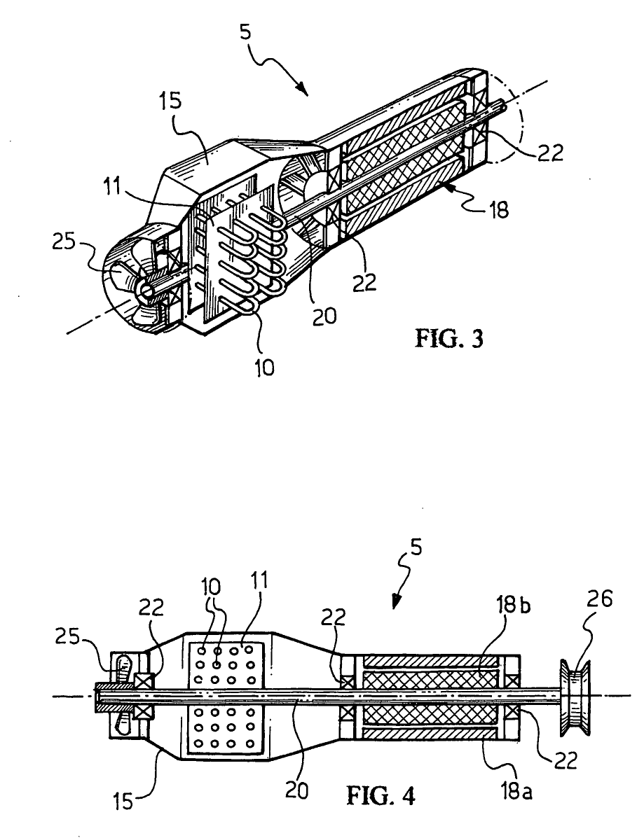

FIGS. 3 and 4 show respectively an axonometric view and a longitudinal section of a detail of the unit in FIG. 1, with a part removed;

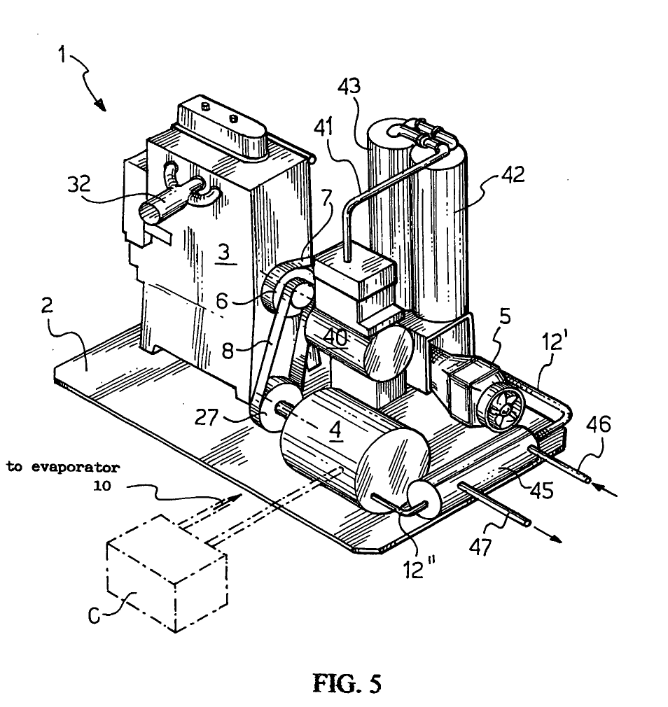

FIG. 5 shows a second example of operating unit according to the invention;

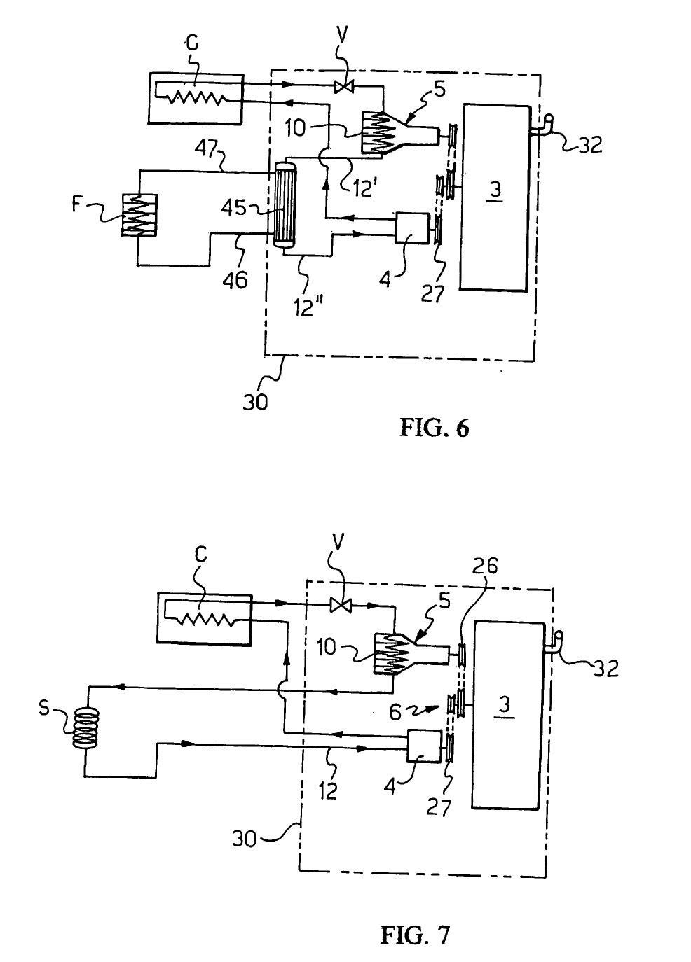

FIGS. 6 and 7 are diagrams which show respective units according to the invention.

With reference to the drawings, numeral 1 denotes overall an operating unit for the production of electric power, of the transportable type which can be used for sea or land applications as referred to above.

This unit comprises a base 2 on which an internal-combustion engine 3, a compressor 4 of a cooling apparatus described in greater detail below and a generator block 5 for the generation of electric power, are fixed.

The engine 3 is preferably of the diesel type, known for these applications and cooled by a liquid which circulates inside it and which exchanges heat with the exterior; in the case of nautical applications or in environments where there is in any case availability of water, this heat exchange may take place inside a liquid/external-water exchanger (not shown in the drawings), while in the case of land applications this exchange may be obtained by means of a radiator.

The output shaft of the engine 3 has, mounted on it, a double-race pulley 6 which actuates by means of respective belts 7 and 8, the compressor 4 and the generator block 5. The cooling fluid processed by the compressor 4 goes first to a condenser C (schematically shown in broken lines in FIG. 1) located outside the unit and then reaches an evaporator 10 arranged inside the generator block 5, consisting of a coil with fins 11; from here the fluid returns then to the compressor by means of a return duct 12.

As can be seen from the figures, the generator block 5 also comprises an external housing 15 containing inside it, in addition to the evaporator 10, an alternator 18 with a stator 18a and a rotor 18b.

The rotor of the alternator is mounted on a shaft 20 which extends from one end to the other of the housing 15, also passing through the evaporator 10; for this purpose, the shaft is supported by bearings 22 having a structure open peripherally so as to allow the axial passage therethrough of an air flow.

Indeed, the housing 15 of the generator block 5 is provided internally with forced ventilation, obtained by means of a fan 25 keyed onto the shaft 20 at the opposite end to that where the pulley 26 is made to rotate by the belt 7; in this respect it is pointed out that a similar pulley 27 is associated with the compressor 4 for operation thereof.

Returning now to what has been mentioned farther above, it must be pointed out that the cooling apparatus, of which the compressor 4 and the evaporator 10 form part, also comprises a condenser (not shown in the drawings) located outside the unit and intended to cool the operating fluid circulating in the apparatus.

Last, it must be stated that the unit 1 is provided with a case or cocoon 30 (in FIG. 1 indicated solely by a dot-dash line) for thermo-acoustic insulation with respect to the external environment.

Advantageously, inside this case controlled-temperature conditions are maintained making use of the air cooled by the evaporator 10 of the cooling apparatus.

For this reason the air which comes out of the generator block 5 and which is rather cool, although it heats up after passing through the alternator 18, is used to maintain controlled-temperature conditions inside the case 30.

This effect is increased by the fact that preferably the air inside the case 30 is always the same, because change of the air is not necessary for operation of the unit owing to the fact that the engine 3 draws in air directly from the outside, by means of a header 32 passing through the case 30.

Similarly the fumes of the engine are evacuated by means of an exhaust pipe (not shown in the drawings) which discharges them outside; in the case where the unit is intended for marine applications, the exhaust pipe may be of the known type with which the cooling water of the engine is also expelled; alternatively it may be of any suitable type.

The functioning of the operating unit 1 takes place as below.

The diesel engine 3 actuates the compressor 4 and the shaft 20 of the alternator 18 by means of belt drives 7 and 8; as a result, the cooling fluid circulates inside the evaporator 10 and the air moved by the fan 25 keyed onto the shaft 20 passes through it, thereby being cooled and allowing thus also the cooling of the alternator 18.

The air then comes out from the housing 15 of the generator block and is dispersed inside the case 30; although it is heated by the heat exchange with the alternator 18, it is nevertheless at a sufficiently low temperature to maintain cool conditions inside the case 30.

Maintaining of these conditions is also favoured by the fact that, as already stated, the case is preferably closed and therefore there is no exchange of air with the exterior which may alter the temperature inside it.

These features provide for the operating unit 1 to be able to function also in hot locations, such as for example open sites exposed to hot summer sun, desert zones and the like.

From the foregoing explanation it is thus possible to understand how the operating unit 1 solves the problem underlying the invention.

Indeed it is clear that the alternator 18 is kept at desired operating conditions owing to the low-temperature air flow obtained with the evaporator 10.

The latter, and more generally the entire cooling apparatus associated with unit 1, will obviously be designed with dimensions suitable for producing the amount of cold necessary to remove the heat produced by the alternator during its operation; this apparatus is however a normal apparatus which operates using a conventional refrigeration cycle.

Furthermore, in accordance with the preferred embodiment of the invention described above, the power for operation of the compressor is provided by the internal-combustion engine (through the belt and pulley drive), without requiring the use of additional electric motors; this makes the functioning of the operating unit structurally simple and reliable, in addition to improving its efficiency.

In simpler words it can be stated that the operating unit according to the invention has the same advantages as those units where the generator is cooled by air (i.e. not by a liquid which could come into contact with the current-conveying parts), ensuring however a cooling efficiency which is much greater owing to the low temperature of the air circulating inside the generator block 5.

Such a unit is therefore suitable for working in a reliable manner even under the heavy conditions referred to farther above, both in sea and land applications; indeed, as it has been shown, cooling of the alternator does not require a heat exchange with external water, thereby making the unit advantageously suitable also for arid zones.

Obviously numerous variants of the invention are possible with respect to the embodiment thereof considered in the drawings.

It has already been mentioned initially that the generator may be an alternator or a dynamo, depending on whether it serves for the production of alternating or direct current; accordingly, there will be therefore components (in particular in the electrical part of the unit) which are different from case to case.

Furthermore it is obvious that the type of mechanical transmission for driving the generator (whether it produces direct or alternating current) and the compressor may differ from the belt and pulley type; for example it may be possible to have gear transmissions or also solutions in which there is no intermediate drive system between the output shaft of the engine and the generator, since the latter is integrally joined to the former by means of a flanged joint or other connection of the rigid type. In this case the generator would therefore be arranged along the axis of rotation of the engine 3.

It must also be pointed out that although the use of a single housing 15 for enclosing the evaporator 10 and the alternator 18 is obviously preferable because it allows the cooled air to be conveyed in an optimum manner to the alternator 18 (keeping at the same time the dimensions as small as possible), this solution however could be modified such that the entire generator block be changed as a result; this will depend, among others, on the form and the dimensions of the evaporator, on the amount of cold required to cool the alternator, on the way in which the forced ventilation is obtained and the so on.

Therefore, it is also possible that in these circumstances the shaft 20 have a shorter length and be used solely for the rotor 18b of the alternator, with the fan operated separately for example by the shaft of the compressor and a belt or pulley transmission similar to those already seen, or by its own electric motor.

From a more general point of view it is necessary to emphasise the fact that the invention must not be regarded as being limited to an operating unit intended solely for the production of electric power.

It may indeed be applied to multi-purpose operating units, namely units capable of performing also other functions in addition to that of generating electric power, such as for example the purification of water for drinking purposes, the air-conditioning of environments or the cooling of a cold-storage room.

Operating units of this type are already known in the art, for example from European Patent Application No. 1120556 filed by the same Applicant of the present application.

FIG. 5 shows a second embodiment of the present invention, designed in accordance with this principle of multi-purpose use; in this case the operating unit differs from that of the first embodiment, in that it is used for purifying water for drinking purposes and the conditioning of external environments.

For this purpose, in addition to the parts already seen above, whose numbering has been kept unvaried in this case, the operating unit 1 comprises a high-pressure pump 40 also actuated by the internal-combustion engine 3.

The pump 40 is of the volumetric type with pistons actuated by means of a crankshaft and connecting rods; this pump and its mechanical components have not been shown in detail in FIG. 5 since they are known per se.

It needs only be added that that crankshaft of the pump is connected to that of the engine 3 where the pulley 6 is keyed, by means of a reducer and a clutch (not shown) so as to allow activation and de-activation of the pump according to requirements.

Obviously, in this case the operating unit receives water from the outside; for example, in the case where it is located on-board a boat, it is possible to envisage an installation of the type illustrated in the abovementioned European patent application, for supplying external water to the intake of the pump 40.

The delivery side 41 of the latter is instead connected to filtration membranes 42 and 43 arranged in series, at the outlet thereof filtered water is obtained that, depending on the circumstances, may be potable or have to undergo a subsequent sterilisation treatment (for example with ultraviolet rays or the like); in the case of seawater the aforementioned membranes will of the reverse-osmosis type so as to obtain, in addition to filtering of the water, also desalination thereof.

In this second example of the invention, the evaporator 10 which is located inside the generator block 5 causes evaporation of only a fraction of the whole cooling fluid processed by the compressor; most of the fluid evaporates instead inside an exchanger 45, where it cools a liquid (typically a mixture of water and ethylene glycol, but it could also be another liquid) circulating inside a conditioning system outside the unit (not shown in FIG. 5).

Inside the exchanger 45 the connections for entry and exit of the conditioning fluid are indicated by 46 and 47 respectively, while the sections of the cooling fluid duct which leads to the compressor are again indicated by 12′ and 12″.

As can be seen, therefore, the unit of this second example, in addition to the advantageous effects relating to cooling of the alternator already mentioned, is able to perform also other functions in a co-ordinated manner and with major synergistic effects.

This is obvious as regards cooling of the alternator and of the conditioning liquid, which are obtained using the same cooling apparatus; in other words the latter is designed with larger dimensions in the second embodiment of the operating unit described above, but its components are substantially the same as those of the first embodiment.

In this way, particular structural and functional modifications to the operating unit are therefore not necessary, apart from different dimensions in one case or the other, due to the overall bulk and to the performance.

Similar considerations apply also to rendering the water drinkable and to air-conditioning.

In fact, although in the unit according to FIG. 5 the pump 40 is used only to supply the membranes 42 and 43, it is nevertheless possible to envisage designing a unit in which this pump is also used for the circulation of the conditioning liquid.

Reference should be made, for example, to the case wherein some of the pistons of the pump are used to supply the water to be purified to the membranes 42 and 43, while other pistons pump the liquid of the conditioning plant; obviously such a pump shall have special mechanical features which are, however, not of interest here.

As an alternative to this solution, it would be possible however to consider providing two pumps (of the piston, centrifugal or other type) which are actuated by the combustion engine 3, i.e. one for supplying the membranes 42 and 43 and the other for pumping the conditioning liquid.

It must also be considered that instead of having conditioning systems wherein the air conditioned in the rooms is obtained by exchanging heat with the aforesaid liquid, it is possible to have systems wherein the air is cooled by exchanging heat with the cooling fluid which evaporates in coils located in these rooms; this does not change, however, the essence of the invention, as can be understood from the illustrative diagrams according to FIGS. 6 and 7, which relate to two operating units applied to respective conditioning systems of the type explained above.

In the diagrams the same numbering has been used to indicate the parts already described above, to which a condenser C and an expansion valve V for the cooling fluid have been added; in the case of the water and glycol system (FIG. 6), the elements arranged in the rooms are schematically represented by a fancoil F, while in the other case the conditioning element is a coil S.

In the same way, finally, it is obvious that the conditioning systems may be replaced by another application, for example by a refrigerating cell; in other words, the evaporator part which in the unit according to FIG. 5 is arranged in the exchanger 45, could instead be located in a normal fridge or other similar compartment to be cooled.

As can be seen, therefore, numerous variants are possible also as regards the second example of operating unit according to this invention, but nevertheless fall within the scope of the following claims.

1. Operating unit comprising an internal-combustion engine (3), an electric power generator (18) connected to the internal-combustion engine for being actuated by it and generating electric power, characterized in that the generator (18) is cooled with cold air obtained by means of a cooling apparatus associated with the operating unit.

2. Operating unit according to claim 1, wherein the cooling apparatus comprises a compressor (4) connected to the internal-combustion engine (3) for being actuated by it and compressing the cooling fluid circulating in said apparatus associated with the unit.

3. Operating unit according to claims 1 and 2, wherein the generator (18) and at least one part of the evaporator (10) of the cooling apparatus are adjacent to each other, and wherein the generator is cooled with ventilated air cooled by the passage trhough said at least one part of the evaporator.

4. Operating unit according to claim 3, comprising a generator block (5) with a housing (15) wherein the generator (18) and said at least one part of the evaporator part (10) are accomodated, inside which forced ventilation is produced for cooling of the generator.

5. Operating unit according to claim 4, wherein the rotor (18a) of the generator is mounted on a shaft (20) which also actuates an impeller (25) for forced ventilation of the housing.

6. Operating unit according to the preceding claims, wherein the cooling apparatus comprises at least one second part of the evaporator downstream of the first part, for cooling a refrigerating compartment or for conditioning rooms, located outside the unit.

7. Operating unit according to claim 6, comprising a heat exchanger (45) accomodating therein said at least one second part of the evaporator, for cooling a room conditioning liquid.

8. Operating unit according to the preceding claims, comprising a case (30) forming an insulating housing wherein the internal-combustion engine (3), the compressor (4) and the generator (18) are accomodated, and inside which predefined temperature conditions are obtained with air cooled by said cooling apparatus.

9. Operating unit according to claim 8, wherein at least one part (10) of the evaporator of the cooling apparatus is located inside the case (30) which is kept at predefined temperature conditions with air cooled by the passage through said evaporator part.

10. Operating unit according to claim 9, wherein the internal combustion engine (3) draws in air from outside the case (30), thereby being able to function also without changing of air inside the case.
